(19) United States
(12) Patent Application Publication
(10) Pub. No.: US 2012/0083220 A1
(43) Pub. Date: Apr. 5, 2012

(54) Determining the quality of service in a communication terminal device

(75) Inventor: Friedhelm Rodermund, Dusseldorf (DE)

(73) Assignee: Vodafone Holding GmbH, Dusseldorf (DE)

(21) Appl. No.: 13/249,573

(22) Filed: Sep. 30, 2011

(30) Foreign Application Priority Data
Oct. 1, 2010 (DE) 102010041877.3-31

(51) Int. Cl. H04W 24/00

(52) U.S. Cl. 455/67.11

(57) ABSTRACT

The invention relates to a method for determining the quality of service of at least one service, whereby several parameters that represent the quality of service are detected in a communication terminal device. With the method, at least one second parameter is associated with at least one first parameter, and the detection of the second parameter is started as a function of the result of a comparison of the first parameter to a prescribed threshold value. Moreover, the invention relates to a communication terminal device which is suitable to carry out the method and which can especially be a mobile communication terminal device.

The invention relates to the monitoring of the quality of service in a mobile terminal device. In particular, the invention relates to a method for determining the quality of service of a service as well as to a communication terminal device with an arrangement for detecting parameters that represent a quality of service.

Communication networks such as, for example, mobile telecommunications networks, provide numerous services for the transmission of speech, multimedia data and messages or communications to the communication terminal devices that are connected to the network. From the vantage point of the user, there are certain requirements for the services, for example, in terms of the speed and reliability or availability of the services. The requirements and the extent to which they are met are also referred to as the quality of service (QoS). The quality of service can be quantified on the basis of the quality of service parameters (QoS parameters). For GSM (Global System for Mobile Communications) and 3G-mobile telecommunications networks, such QoS parameters are described, for example, in the document TS 102 250 of the European Telecommunications Standards Institute (ETSI), especially in its second part (TS 102 250-2).

In order to ensure that a certain quality of service is provided in a communication network, the quality of service can be monitored. For this purpose, QoS parameters can be detected at various measuring points within the communication network and can be evaluated by the network service provider. The evaluation can be used, for example, in order to optimize the network. The measuring points can be located in the communication network within the network nodes contained therein. Moreover, QoS parameters can be measured in the communication terminal devices that are connected to the communication network. This makes it possible to determine the quality of service from the vantage point of the user of the services, that is to say, where the services are being used.

Numerous QoS parameters in terms of the performance of the services and the performance of the communication network can be detected in order to determine the quality of the service. For this purpose, one or more software applications can be used in a communication terminal device in order to detect the QoS parameters while the services in question are being accessed by the terminal devices. The communication terminal devices can send the detected values of the QoS parameters to appropriate equipments of the communication network in order to be evaluated. The evaluation of the quality of service and of the factors that influence the quality of service can be improved by a higher number of detected QoS parameters. However, as the number of QoS parameters to be measured increases, the measuring effort also increases and so does the associated capacity utilization of the communication terminal devices due to the measurements.

Particularly in mobile communication terminal devices, which generally have only limited resources, especially computing capacity and memory, the detection of a large number of QoS parameters generally causes a reduction in the capacity that is available to carry out the services and other tasks. For this reason, the QoS measurements in the communication terminal devices are normally limited to just a few QoS parameters. In this context, it has to be accepted that fewer QoS parameters will be available for the evaluation.

It is an objective of the present invention to reduce the resources utilized in a terminal device to detect QoS parameters.

This objective is achieved by a method according to claim 1 and by a communication terminal device according to claim 13. Embodiments of the method and of the communication terminal device are put forward in the dependent claims.

According to a first aspect, the invention proposes a method for determining the quality of service of at least one service, whereby several parameters that represent the quality of service are detected in a communication terminal device. With the method, at least one second parameter is associated with at least one first parameter, and the detection of the second parameter is started as a function of the result of a comparison of the first parameter to a prescribed threshold value.

According to a second aspect of the invention, a communication terminal device with an arrangement for detecting several parameters that represent the quality of service is provided. An association between at least one first parameter and at least one second parameter is stored in the terminal device. The arrangement for detecting the parameters that represent the quality of service is configured to start the detection of the second parameter as a function of the result of a comparison of the first parameter to a prescribed threshold value.

By starting the detection of the second parameter as a function of the result of a comparison of the first parameter to the prescribed threshold value, the possibility is created that, during the normal operation of the terminal device, not all of the relevant parameters that represent the quality of service have to be detected. During normal operation, the detection can be limited to the first parameter whereas the second parameter is detected only in special situations that are determined on the basis of the comparison. This reduces the overall resources that are used to detect QoS parameters. Particularly during normal operation, the capacity utilization of resources due to the detection of QoS parameters can be reduced.

In one embodiment of the method and of the communication terminal device, it is provided that the detection of the second parameter is started when, on the basis of the comparison, it is ascertained that the first parameter has exceeded or fallen below the threshold value. Preferably, exceeding or falling below the threshold value indicates a deterioration of the first parameter. Thus, in this embodiment, it is achieved that the detection of the second parameter is started (only) when the value of the first parameter indicates that a deterioration of the quality of service has taken place or is probable.

In another embodiment of the method and of the communication terminal device, the detection of the second parameter is started when several first parameters have each exceeded or fallen below a given threshold value. In comparison to the detection of the second parameter as a function of the result of a comparison of one single first parameter to a prescribed threshold value, this embodiment can have the advantage that, due to the values of the plurality of first parameters, there is a more specific indication of a deterioration of the quality of service, and this renders the detection of a specific second parameter or of specific second parameters advisable. In this manner, the unnecessary detection of QoS parameters can be further reduced.

A variant of the method and of the communication terminal device comprises that at least one second parameter is selected that potentially influences the first parameter. Advantageously, in this case, it can be determined whether the deterioration of the first parameter is due to a cause that can be determined on the basis of the second parameter.

Another variant of the method and of the communication terminal device provides that a second parameter is selected that potentially likewise changes if the first parameter changes, but without influencing the first parameter. In this manner, it can be determined whether the deterioration of the first parameter is associated with a deterioration of the second parameter, which can be, for example, a related parameter that refers particularly to the same service as the first parameter.

The last-mentioned second variant can be provided as an alternative to the first variant. However, both variants can also be combined. In particular, one of the second parameters can be selected in such a way that it potentially influences the first parameter, and another second parameter can be selected in such a way that it likewise changes when the first parameter changes, but without influencing the first parameter.

One embodiment of the method and of the communication terminal device provides that the first parameter is representative of the quality of an output of acoustic and/or optical information to the communication terminal device. This makes it possible to reliably determine the quality or quality of service with which the services on the communication terminal device are made available to the user.

The second parameter, especially in the above-mentioned second variant, can likewise be representative of the output quality of acoustic and/or optical information.

In another embodiment of the method and of the communication terminal device, the second parameter is representative of the quality of the data transmission between the terminal device and a communication network. In particular, the second parameter can be representative of the data transmission speed between the terminal device and the communication network. QoS parameters that relate to the quality or speed of the data transmission generally influence the quality of the output of information on the terminal device and can therefore be selected as second parameters, especially in the case of the above-mentioned first variant.

In another embodiment of the method and of the communication terminal device, it can be provided that the first parameter indicates the playback quality of a video data stream or of an audio data stream. Especially when a so-called streaming service is used for the playback of such a data stream, as a rule, there are very high requirements for a flawless playback in terms of quality, especially the speed, of the data transmission between the terminal device and the communication network. Consequently, in the case of a deterioration of the playback quality, it is advantageous to detect one or more second parameters that are representative of the data transmission speed in order to ascertain whether a reduced data transmission speed is a cause for the deterioration of the playback quality.

Furthermore, one embodiment of the method and of the communication terminal device is characterized in that values of the first and/or second parameters detected in the terminal device are sent via the communication network to a network server. The network server can undertake, for instance, a logging and/or an evaluation of the received parameters. The results of the evaluation can be used, for example, by the operator of the communication network in order to optimize the network.

The threshold value of the first parameter or the threshold values of the plurality of first parameters are preferably selected in such a way that an essentially unaffected quality of service is present as long as the values do not exceed or fall below the threshold value. Thus, the transmission of the detected values of the first parameter is not absolutely necessary in any case. The transmission can be started when an impairment of the quality of service has been recognized because the value has exceeded or fallen below the threshold value. One embodiment of the method and of the communication terminal device comprises that the trans-mission of the detected values of the first parameter to the network server is started at with the detection of the second parameter.

The communication terminal device can especially be a mobile communication terminal device, and the communication network can be configured as a wireless communication network, especially as a mobile telecommunications network. In such networks, the quality of services provided is generally influenced by numerous factors, which especially have to do with the wireless access to the communication network. Therefore, the proposed detection of QoS parameters in such networks is especially advantageous.

The detected first and second parameters can relate to a single service which the terminal device accesses, or to a plurality of services. The services can especially be provided via the communication network to which the terminal device can be connected. The services can comprise one or more services from the group containing services for transmitting speech and messages or communications as well as multimedia data containing audio and/or video or image data, as well as other data and services for data transmission via the communication network. The services can build on each other as can be the case, for example, with a service for the playback of contents and an underlying transmission service, or else the services can be carried out in parallel to each other.

According to another aspect, the invention proposes a system that comprises the communication terminal device or an embodiment or variant of the communication terminal device as well as a network server that is configured to receive values sent by the mobile terminal device.

Furthermore, in another aspect, the invention proposes a computer program that comprises a software code with commands for executing the method or one of its embodiments by means of a processor. The processor can especially be contained in the communication terminal device.

The above-mentioned as well as additional advantages, special features and practical refinements of the invention are also explained on the basis of the embodiments which will be described below making reference to the FIGURE. The following is shown:

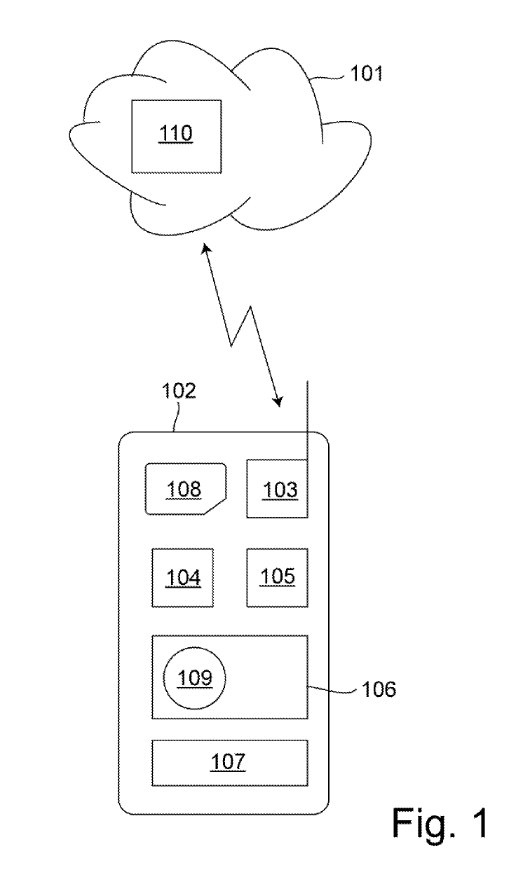

FIG. 1 a schematic representation of a communication terminal device that is connected to a communication network and configured for detecting QoS parameters.

The communication network 101 schematically shown in FIG. 1 preferably provides a plurality of services for the transmission of speech and messages or communications as well as multimedia data containing audio and/or video or image data, as well as other data that can be accessed by means of communication terminal devices 102 that are connected to the communication network 101.

Examples of services that can be provided in the communication network are telephony and video-telephony for the transmission of speech and video data as well as SMS (Short Messaging Service), e-mail, MMS (Multimedia Messaging Service) and IM (Instant Messaging) for the transmission of messages or communications. Examples of services for the transmission of multimedia and other data are streaming services for receiving audio data streams and/or video data streams, radio reception (mobile broadcast), access to the Internet or to the World Wide Web (web browsing) and services for transferring files.

In one embodiment, the communication network 101 is a network that comprises a core network as well as a wireless access network (not shown in the FIGURE), via which terminal devices 102 can be connected to the core network wirelessly. The communication network enables data transmission to and from the connected communication terminal devices 102 via line switching and/or packet switching connections. In particular, the communication network 101 can be a mobile telecommunications network that can be configured, for example, according to the GSM, UMTS (Universal Mobile Telecommunications System) and/or LTE (Long Term Evolution) standard of the 3rd Generation Partnership Project (3GPP) or according to the WIMAX (Worldwide Interoperability for Microwave Access) standard. By the same token, the communication network 101 can also be configured as a different type of wireless network, for example, a WLAN (Wireless Local Area Network).

A plurality of terminal devices 102 can be connected to the communication network 101 and one of them is shown in FIG. 1 by way of an example, to which reference will be made below. The other terminal devices 102 can be configured in a similar manner and they function like the terminal device 102 shown here.

The terminal device 102 comprises a radio module 103 to establish the connection to the communication network 101 via the access network. In order to output information and to detect user input, a user interface is provided that comprises output means 104 and input means 105. The output means 104 preferably comprises a display unit for the visual output of information as well as one or more loudspeakers for the acoustic output of information. The input means 105 can comprise a keyboard as well as a joystick or similar input device. As an alternative or in addition, it is also possible for a touch screen to be provided as an input means 105. In order to control the terminal device 102 and to execute application programs, a main processor 106 is provided that is connected to a memory 107 for storing the control and application software as well as additional data. By the same token, the main processor is connected to the other components of the terminal device 102 in order to control them and/or to receive data.

An identification card 108 can be inserted into the terminal device 102, and it contains data and can execute functions for identification or authentication within a communication network 101 that is configured as a mobile telecommunications network. The identification card 108 is a chip card that has its own processor as well as a memory, which are not shown in the FIGURE. For use in one of the above-mentioned mobile telecommunications networks according to a 3GPP standard, the identification card 108 can comprise a SIM (Subscriber Identity Module) card or can contain a USIM (Universal Subscriber Identity Module). In order to determine QoS parameters within the terminal device 102, the terminal device 102 contains a QoS unit 109. As schematically illustrated in the FIGURE, the QoS unit 109 is a software program that is executed on a processor of the terminal device 102. In a preferred embodiment, the main processor 106 of the terminal device 102 is provided in order to execute the software application. Fundamentally, however, the QoS unit 109 can also be executed on another processor that is present in the terminal device 102, for example, in the processor of the identification card 108.

The QoS unit 109 contains functions for measuring QoS parameters. As an alternative or in addition, the QoS unit receives QoS parameter values that have been detected in additional software programs and/or in hardware units of the terminal device 102, whereby the detection of QoS parameters there is likewise preferably controlled by the QoS unit 109. The monitoring or detection of the QoS parameters can be started in prescribed situations, for instance, whenever the terminal device 102 is switched on, and/or whenever a given service is started. After the monitoring begins, QoS parameter values can be detected, for example, at prescribed time intervals or else event-based.

Via the communication network 101, the QoS unit 109 can transmit the QoS parameter values determined in the terminal device 102 to a QoS server 110 of the network. In order to transmit the QoS parameter values, a message can be sent by the terminal device 102 to the QoS server 110 via a message service that is also accessible for the users of the terminal device 102, for example, by SMS. The message in question can be generated by the QoS unit 109 and can be sent transparently, i.e. in such a way that it is invisible to the user. By the same token, other transmission protocols can be used for the transmission of the QoS parameter values such as, for instance, HTTP as well as transmission protocols specially provided for automatic data transmission. An example of this is the protocol specified by the Open Mobile Alliance (OMA) for Device Management (DM). The detected QoS parameter values can be transmitted by the QoS unit 109 at regularly prescribed time intervals or else event-controlled.

The configuration data that is stored in the terminal device 102, for instance, in the memory 107, contains the QoS parameters that are to be detected, the conditions under which the monitoring of the QoS parameters are to be detected, the detection mode including the prescribed time intervals and/or the events for the detection, the transmission mode including the time intervals provided for the transmission and/or the events that trigger the transmission as well as, if applicable, additional information that determines the behavior of the QoS unit 109. In one embodiment, the configuration data can be viewed and changed by means of a configuration module of the QoS unit 109 on the terminal device.

As an alternative or in addition, it can be provided that the configuration data can be prescribed or changed by the QoS server 110. For this purpose, the QoS server 110 can send appertaining configuration messages via the communication network 101 to the terminal device 102 making use of a suitable protocol, and these messages are forwarded, preferably transparently, to the QoS unit 109. An example of a suitable protocol is the above-mentioned protocol of the OMA for device management.

By prescribing the configuration, the operator of the communication network 101 who can also control the QoS server 110 can adapt the detection of QoS parameters to its needs or to the conditions of the communication network 102, without having to manually configure the terminal devices 102. For example, the network operator can configure the QoS units 109 of the terminal devices 102 that are connected to the communication network 101 in such a manner that QoS parameters are detected that are related to known weak points of the network while avoiding the detection of QoS parameters that are related to services that are used reliably and without any problems.

The QoS server 110 preferably receives QoS parameter values that are sent by a plurality of terminal devices 102 that are connected to the communication network 101. For all of the terminal devices 102, the transmission can be carried out in a similar manner to that described above. Moreover, the QoS server 110 can also receive measured QoS parameter values that have been detected at additional measuring points. Such measuring points can especially be network nodes or servers, which are not shown in the FIGURE, and they can detect QoS parameters and send the detected values to the QoS server 110. An evaluation of the received QoS parameters can be carried out in the QoS server 110. In this process, for example, low qualities of service can be identified and analyzed. The evaluation can be used by the operator of the communication network 101, for example, in order to optimize the communication network.

Fundamentally, numerous QoS parameters can be detected within the terminal device 102. For example, some or all of the QoS parameters can be determined that are explained in the ETSI document TS 102 250, especially in part 2 (TS 102 250-2). Moreover, additional QoS parameter values that are known to the person skilled in the art can be detected in the terminal device 102.

In one embodiment, the QoS parameters that can be detected in the terminal device 102 can be allocated to two or more planes or layers.

At least one first plane can comprise the QoS parameters that relate to the data transmission via the interface between the terminal device 102 and the communication network 101 which, in the case of a wireless communication network, is configured as an air interface. These parameters can especially comprise the speed of the data transmission and/or the signal strength of the wireless access network. Examples of such QoS parameters are the transmission rate with which the data is received from the communication network 101 (so-called downlink data rate) and can be sent to the communication network 101 (so-called uplink data rate), the loss ratio for data packets (packet loss ratio) sent to the terminal device 102 (via a packet switching connection), as well as the access network signal strength received in the terminal device 102, and additional radio parameters that are known to the person skilled in the art.

Parameters that can be considered to belong to a higher layer relate to the execution or provision of services that the user of the terminal device 102 accesses and that are provided for the playback of information on the terminal device 102. Such QoS parameters can be a measure of the speed and/or the quality with which the services can be accessed and/or with which information is output to the terminal device 102. Examples of such parameters are the output quality of audio data streams and/or video data streams with streaming services (streaming audio quality or streaming video quality), the time offset between the audio signal and the video signal in video data streams (streaming audio/video de-synchronization), the speech quality (telephony speech quality) and die cut-off ratio (telephony cut-off call ratio) in speech telephony services as well as corresponding parameters in video telephony services.

In order to reduce the capacity utilization of the resources by QoS measurements, not all of the QoS parameters that can be detected are actually determined in the terminal device 102 during normal operation. It is provided that a first QoS parameter is monitored in certain situations. One or more second QoS parameters that are detected if (additional) conditions have been fulfilled are associated with the first QoS parameter. The additional conditions are prescribed with respect to the value of the first QoS parameter. The presence of the conditions is ascertained when a comparison of the value of the first QoS parameter to a prescribed threshold value is made, and it is ascertained that the QoS parameter value has exceeded or fallen below the threshold value.

Below, the plural is used to refer to one or more second QoS parameters. Unless explicitly stated otherwise, this also refers to precisely one QoS parameter if only one single QoS parameter is associated with the first QoS parameter.

The first QoS parameter and the second QoS parameters as well as the threshold value and the criterion that is decisive for the detection of the second QoS parameters (exceeding or falling below the threshold value) are stored in the terminal device 102 as an integral part of the configuration data of the QoS unit 109. As is the case for the other configuration data of the QoS unit 109, it can also be provided for this configuration data that it can be adapted by the QoS server 110.

In one embodiment, exceeding or falling below the threshold value of the first QoS parameter indicates a deterioration of the first QoS parameter, which can lead to a deterioration of one or more services or can be associated with such a deterioration.

In one embodiment, the deterioration can be further analyzed on the basis of the second QoS parameters. A cause for the deterioration can be determined for example, if the second QoS parameters are suitably selected. In this embodiment, the first QoS parameter can be a QoS parameter of the upper layer that relates to the execution of a specific service. The second associated parameter can be a parameter of a lower layer that relates to the data transmission between the terminal device 102 and the communication network 101. In this manner, it can especially be determined whether a deterioration displayed or indicated on the basis of the first QoS parameter in the provision of the service in question can be ascribed to a deterioration of the data transmission. In particular, the first QoS parameter can be the quality of a video stream and the second QoS parameter or second QoS parameters can be one or more of the group of parameters comprising the transmission rate, the packet loss ratio and the radio signal strength.

In another embodiment, the first QoS parameter as well as the associated second QoS parameters belong to one layer and both of them particularly relate either to the provision of services for the user or else to the data transmission. In this manner, for example, it can be checked whether a deterioration in the provision of a specific service for the playback of information on the terminal device 102—which is indicated by the fact that the first QoS parameter exceeds or falls below the threshold value—is associated with an additional deterioration in the provision of the same service or of another service, which shows up in another QoS parameter that is associated with the first QoS parameter. Thus, for example, it can be provided that the detection of the quality of an audio stream, of a video signal, or of the synchronicity between the audio data stream and the video data stream is started when it is ascertained that the quality of the video data stream of the video signal has fallen below a prescribed threshold value.

The detection of the first QoS parameter can be started, for example, when the terminal device 102 is switched on and/or when a service to which the first QoS parameter relates is started. When the QoS unit has ascertained the start of the service, the detection of the first QoS parameter can be carried out, or the QoS unit 109 can instruct the software program of the terminal device 102 that is providing the service or else another software program or a hardware unit to detect the first QoS parameter and to transmit the detected values to the QoS unit 109.

The detected values of the first QoS parameter can be reported by the QoS unit 109 to the QoS server 110 in the manner described above. Preferably, however, the threshold value is selected in such a way that the quality of service is essentially not affected as long as the first QoS parameter has not exceeded or fallen below the threshold value. Consequently, there is no need to transmit the detected values of the first QoS parameter to the QoS server 110.

During the monitoring of the first QoS parameter, the QoS unit 109 compares the detected values of the first QoS parameter to the prescribed threshold value in order to ascertain whether a value exceeds or falls below the threshold value. If the QoS unit 109 has ascertained that the first parameter has exceeded or fallen below the threshold value, then the detection of the second parameter is started. Once again, the detection is either carried out by the QoS unit 109, or else the QoS unit 109 instructs a software program or a hardware unit of the terminal device 102 to detect the second QoS parameters and to transmit the detected values to the QoS unit 109. After the start of the monitoring of the second QoS parameter, values of the QoS parameter can be detected at regular time intervals or, as an alternative, event-based.

The detected values of the second parameters and preferably the detected values of the first QoS parameter are transmitted by the QoS unit 109 preferably to the QoS server 110, once it has been ascertained that the first QoS parameter has exceeded or fallen below the threshold value. In this manner, the QoS server 110 is informed about the deterioration of the quality of service that has occurred in this case. The detected QoS parameter values can be transmitted in the manner described, for example, at regular time intervals.

The detection of values of the second QoS parameters can be continued for as long as the first QoS parameter is being detected. This can be the case, for instance, as long as the terminal device 102 is switched on or the service to which the first QoS parameter in the terminal device 102 relates is being carried out or as long as the service is being accessed.

By the same token, it can be provided that the detection of the second QoS parameter is ended as a function of the result of a comparison of the first QoS parameter to a threshold value. Here, if the detection has started when the first QoS parameter exceeds a threshold value, this detection can be ended when the first QoS parameter has fallen below a threshold value, and, if the detection has started when the first QoS parameter falls below a threshold value, this detection can be ended when the first QoS parameter exceeds a threshold value.

The threshold value that is decisive for ending the detection of the second QoS parameters can correspond to the threshold value that is decisive for the start of the detection. However, it is also possible for another threshold value to be provided in order to generate a hysteresis. For this purpose, the threshold value that is decisive for the termination is selected to be smaller than the threshold value that is decisive for the start, if the detection is started because the decisive threshold value was exceeded, and vice versa. In this manner, it is can be prevented that the detection of the second QoS parameters is repeatedly started and ended when the value of the first parameter fluctuates around the threshold value.

Whereas in the embodiment described above the detection of the second QoS parameters is started as a function of the detection of a first QoS parameter, in another embodiment, it is provided that the detection of the second QoS parameters is started when several first QoS parameters each exceed an appertaining prescribed threshold value. In this manner, the detection of the second QoS parameter or second QoS parameters can be made dependent on the presence of several conditions whose combination can give a more specific indication that the detection of one or more additional QoS parameters is advantageous. For example, it can be provided that the above-mentioned QoS parameters, which refer to the data transmission between the terminal device 102 and the communication network 101, are detected when the quality of a video data stream as well as the quality of the associated audio data stream have each fallen below a prescribed threshold value.

Although the invention was described in detail in the drawings and in the description above, these are meant for illustration purposes and as examples, and should not to be construed as being limiting in any manner whatsoever. In particular, the invention is not restricted to the explained embodiments. Thus, the invention can also be implemented in wired communication networks and making use of additional or different QoS parameters. The person skilled in the art can glean additional variants of the invention and their execution from the preceding disclosure, from the FIGUREs and from the patent claims.

In the patent claims, terms such as “encompass”, “comprise”, “contain”, “have” and the like do not exclude additional elements or steps. The use of the indefinite article does not preclude the plural. Each individual device can execute the functions of several of the units or devices cited in the patent claims. The reference numerals indicated in the patent claims are not to be construed as a limitation of the means and steps employed.

What is claimed is:

1. A method for determining the quality of service of at least one service, whereby several parameters that represent the quality of service are detected in a communication terminal device, the method comprising:
associating at least one second parameter with at least one first parameter; and
starting detection of the second parameter as a function of the result of a comparison of the first parameter to a prescribed threshold value.

2. The method recited in claim 1, comprising starting detection of the second parameter if, on the basis of the comparison, it is ascertained that the first parameter has exceeded or fallen below the threshold value.

3. The method recited in claim 2, wherein exceeding or falling below the threshold value indicates a deterioration of the first parameter.

4. The method recited in claim 1, comprising starting detection of the second parameter when several first parameters have each exceeded or fallen below a given threshold value.

5. The method recited in claim 1, comprising selecting a second parameter that potentially influences the first parameter.

6. The method recited in claim 1, comprising selecting a second parameter that potentially likewise changes if the first parameter changes, but without influencing the first parameter.

7. The method recited in claim 1, wherein the first parameter is representative of the quality of an output of acoustic and/or optical information to the communication terminal device.

8. The method recited in claim 7, the first parameter indicating a playback quality of a video data stream or of an audio data stream.

9. The method recited in claim 1, the second parameter being representative of the quality of the data transmission between the communication terminal device and a communication network to which the communication terminal device is connected.

10. The method recited in claim 1, comprising sending detected values of the first and/or second parameters by the communication terminal device via the communication network to a network server.

11. The method recited in claim 10, comprising starting the transmission of the detected values of the first parameter to the network server with the detection of the second parameter.

12. One or more non-transitory computer-readable storage media for storing computer-readable instructions, the computer-readable instructions providing a method of determining the quality of service of at least one service when executed by one or more processing devices, whereby several parameters that represent the quality of service are detected in a communication terminal device, the computer-readable instructions comprising code configured to:
associate at least one second parameter with at least one first parameter; and
start detection of the second parameter as a function of the result of a comparison of the first parameter to a prescribed threshold value.

13. A communication terminal device with an arrangement for detecting several parameters that represent the quality of service, comprising:
a terminal device that stores an association between at least one first parameter and at least one second parameter; and
the arrangement being configured to start the detection of the second parameter as a function of the result of a comparison of the first parameter to a prescribed threshold value.

14. The communication terminal device recited in claim 13, the communication terminal device being configured in such a way that detected values of the first and/or second parameters are sent via a communication network to a network server that is connected to the communication network.

15. A system, comprising:
a communication terminal device with an arrangement for detecting several parameters that represent the quality of service, the communication terminal device comprising:
a terminal device that stores an association between at least one first parameter and at least one second parameter; and
the arrangement being configured to start the detection of the second parameter as a function of the result of a comparison of the first parameter to a prescribed threshold value; and
a network server that is configured to receive values sent by the mobile terminal device.

16. The system recited in claim 15, the terminal device being configured in such a way that detected values of the first and/or second parameters are sent via a communication network to the network server, the network server being connected to the communication network.
